(19) United States
(12) Patent Application Publication
(10) Pub. No.: US 2014/0367968 A1
(43) Pub. Date: Dec. 18, 2014

(54) DEVICE AND METHOD FOR PROTECTING A WIND GENERATOR IN THE EVENT OF VIOLENT WINDS AND WIND GENERATOR PROVIDED WITH SUCH A DEVICE

(71) Applicant: Pascal Cuzenard, Drancy (FR)

(72) Inventor: Pascal Cuzenard, Drancy (FR)

(21) Appl. No.: 14/363,822

(22) PCT Filed: Dec. 6, 2012
(86) PCT No.: PCT/FR2012/000504

§ 371 Date: Jun. 9, 2014

(30) Foreign Application Priority Data
Dec. 7, 2011 (FR) 11/03739

(51) Int. Cl. F03D 7/02; F03D 9/00

(52) U.S. Cl. CPC F03D 7/022; F03D 9/002; F03D 7/0268
USPC 290/44

(57) ABSTRACT

A device making it possible considerably and remotely to reduce the diameter of the rotor of a wind generator (1) includes a connecting piece (5) connecting the blade (6) to the hub (4) of the wind generator (1), the central axes (B1-B2) of the respective ends (5.1-5.2) of which components form a certain angle (α), the end (5.1) is able to rotate about its central axis (B1) causing the blade (6) to pivot and once the blade has pivoted it is inclined toward the nacelle (3). When the blade (6) is inclined in this way, the connecting piece (5) and the rotor are immobilized, forming the position in which the wind generator (1) is protected. The device is intended to allow optimum and safe operation of the wind generators in regions subjected to violent winds.

### TECHNICAL FIELD

The invention relates to the field of horizontal-axis wind generators, hereinafter referred to as “wind generators”, and particularly to a device and method for protecting a wind generator in the event of violent winds as well as a wind generator provided with such a device.

The device according to the invention is particularly intended to allow the optimum and safe operation of wind generators in regions subject to violent winds, such as tropical cyclones. The principle of the present invention consists, in the event of violent winds, in significantly reducing the diameter of the blade rotor of the wind generator and then blocking said rotor to form a position for protecting the wind generator in the event of violent winds.

The electricity production from the primary resource, which is the wind, allows to produce electricity without emitting greenhouse gas. In addition, this primary resource is free and renewable contrary to fossil resources. Finally, as the primary resource is local, the electricity production from this resource actively contributes to the autonomy and the energy security of the countries exploiting it.

The starting point of the load spectrum acting on a wind generator are the loads acting on the blade rotor. The loads acting on the blade of the rotor are transmitted to the other components and determine in a large extent the loads affecting them. The main external condition causing these loads is the wind. Typically, the higher the wind speed and the larger the diameter size of the blade rotor, the more trying the aerodynamic load of the rotor due to the wind is for the wind generator.

The electricity production of a wind generator is proportional to the surface swept by the blade rotor, thus to the length of the blades as well as the wind speed. Typically, the lower the average wind speed, the larger the diameter size of the rotor of the wind generator must be for optimally producing electricity.

The conceptual studies of blade rotors of wind generators envisage two wind regimes, the leading, normal conditions and the occasional, extreme conditions. Since, in nature, the extreme conditions do not correlate with the normal conditions, the diameter size selection of the blade rotor therefore results from a compromise between its optimization for the normal conditions, in order to optimize the electricity production, and its optimization for the extreme conditions, in order to reduce the trying load impact induced by these conditions on the wind generator.

It follows from the above that the probability of occurrence of extreme wind conditions on a site, for example a tropical cyclone, is a factor which significantly limits the optimum size selection of the rotor diameter for the normal wind conditions. Most often, the speed as well as the other features of the wind of these extreme conditions, such as turbulence and gusts, make it impossible to install a conventional wind generator for an optimum and safe operation, since the incurred risk is the premature fatigue of components or the machine destruction.

Accordingly, it would be advantageous to provide a specific device allowing to significantly reduce the blade rotor diameter of the wind generator, in the event of violent wind forecast. This would reduce the impact of negative loads induced by these extreme conditions, which would allow to install wind generators having an optimized rotor diameter size for the normal wind conditions in regions subject to violent winds.

### PRIOR ART

The analysis of the prior art shows that solving this problem of reducing the diameter size of the rotor of the wind generator has already been tried.

For example, the documents U.S. Pat. No. 6,972,498, U.S. Pat. No. 7,632,070, US 20100310374 and CA 2696822 are known. These devices relate to blade rotors with varying sizes, the blades of which are telescopic, retractable or extensible and are mainly intended to adapt the surface swept by the blade rotor, thus the blade length, during the different operating states of electricity production of the wind generator at variable wind speeds of the site where it is installed. Typically, the diameter size of the rotor is at its maximum under low wind condition and at its minimum under high wind condition, with intermediate states. These devices require specific structural arrangements for the blades which, during their service life of about 20 years, undergo up to 10⁸ load cycles which, are partly highly variable and non-uniform. These structural arrangements adversely affect the rigidity and the strength of the blades, and thus their reliability, in addition to being costly in maintenance.

Also known is the document U.S. Pat. No. 7,071,578 relating to a wind generator having a system for actively adjusting the flat annular surface that the blade rotor constitutes according to the wind speed. This document suggests the use of a curved connection bend for actively securing the blade of the wind generator to the hub of the wind generator. The rotation of this bend causes the blade to tilt in the direction of the rotation axis of the hub and thus allows to actively vary the diameter size of the rotor of the wind generator according to the wind speed, and thus to optimize the electricity production while reducing the fatigue of the components. Said active rotation of the connection bend is operated according to an angle α in the direction opposite to that of the nacelle so as to allow the rotor to rotate without colliding with the wind turbine tower. The aerodynamic load due to the wind of the rotor actively inclined with respect to the rotation plane according to the wind speed is particularly complex, which makes this device difficult to design and implement. In addition, the used connection bend is a curved hollow tube, the walls of which represent a significant mass adversely impacting the wind generator sizing.

Also known is the document US 20060045743 which relates to folding blades for a wind generator. The structural arrangements of the blade, required for such a device, significantly increase its mass and alter its rigidity and its strength, thus its reliability. In addition, the aerodynamic load due to the wind on the folded blade is complex, especially in the event of violent winds, which makes this device difficult to design and implement. Furthermore, this device contributes to an increase in the maintenance costs of the blade.

It follows from the above that it would be advantageous to provide a simple and specific technical solution allowing to reduce the extreme loads induced by the violent winds on the wind generator, particularly the tropical cyclones, by significantly reducing the diameter of the blade rotor, and without the drawbacks raised in the prior art. This would allow to design wind generators having an optimized rotor diameter size for the normal wind conditions, and thus to install wind generators with an optimal and safe operation in regions subject to these violent wind events.

The purpose of the present invention is to provide a specific solution to this problem and to overcome the drawbacks of known devices, by providing a device which is easy to design, produce, install, use and maintain while being effective, robust and economical.

### DISCLOSURE OF THE INVENTION

An object of the present invention is a device for protecting the wind generator in the event of violent winds which comprises, according to a first feature, a part for connecting a wind generator blade to the hub of said wind generator. The blade-connecting part-hub assembly forming the rotor of said wind generator, which comprises one or several blade(s), and as many connecting parts as blades, is driven in a rotating movement by the wind thrust force, driving a power transmission system which drives in turn an electrical generator which produces electricity. The power transmission system and the generator are housed within a nacelle rotatably mounted on a support tower via an orientation mechanism behind the rotor. Both ends of said connecting part, one connected to the hub and the other connected to the blade, are characterized by the fact that their respective central axis forms a non-zero angle with respect to each other, the connecting part is adapted to be connected to the hub via a drive mechanism such that said connecting part can rotate around the central axis of its end connected to said hub, the operation of this drive mechanism causes tilting according to an angle of the blade which is adapted to be connected to the other end of the connecting part via a variable pitch setting mechanism, when said blade is tilted, it is inclined according to said angle in the direction of the nacelle, which significantly reduces the diameter size of the rotor when this operation is performed on all connecting parts connected to the hub of said wind generator. The connecting parts of each of the blades are adapted to be blocked by rigidly coupling with the hub by blocking elements, the power transmission system of said wind generator is also adapted to be rigidly blocked by blocking elements blocking the rotation of the blade rotor. Thus, the blades inclined in the direction of the nacelle, the connecting parts rigidly blocked to the hub and the blocked rotation of the rotor form the protecting position of said wind generator, remotely controllable in the event of violent winds.

According to other features of the device according to the invention:
said hub comprises a port at each connecting part location;
said both ends of the connecting part are circular connecting flanges connected by a hollow tube, the walls of which facing said ends are partially removed and connected by reinforcing bars;
said end of the connecting part connected to the hub is at a distance from the central axis of the other end of said connecting part connected to the blade;
said other end of the connecting part connected to the blade is at a distance from the central axis of the end of said connecting part connected to the hub;
said connecting parts are connected to the hub at equal distances from each other in the case of said rotor comprising several blades, and in the circumferential direction of said hub, the central axis of the end of said connecting part connected to said hub extends in a radial direction with respect to the rotation axis of said hub;
said drive mechanism, through which the connecting part is connected to the hub, can be a friction or non-friction or low-friction drive mechanism, said drive mechanism can incorporate, but is not limited to, a crown, the upper internal periphery of which is toothed, this toothed crown is circularly attached to the end of the end of the connecting part connected to the hub, a pinion meshing with the teeth of said toothed crown, said pinion is operated by a reversible electrical motor, a rolling bearing is attached to the lower internal periphery of said toothed crown and to the external periphery of the port of said hub such that said end of said connecting part connected to the hub can rotate around its central axis when said motor is operated, said motor is adapted to be controlled by a control-command device which is adapted to be connected to the control-command of said wind generator;
said rigid coupling of said connecting part to the hub is performed via blocking elements, it may be any type of blocking elements, these blocking elements can incorporate, but are no limited to, plates provided on the end of said connecting part above said toothed crown for the first blocking elements and on said hub for the second blocking elements, said plates protruding toward the central axis of said end of said connecting part connected to the hub perpendicularly to said central axis;
said first and second blocking elements being provided with conical holes adapted to be aligned with each other when said connecting part must be blocked;
a conical locking rod, comprising a fixed upper part which is adapted to receive a lower part adapted to vertically move, forms the third blocking elements, said lower part of the locking rod is adapted to be inserted in said aligned holes for rigidly coupling said connecting part with the hub;
said fixed upper part of said locking rod is adapted to receive hydraulic means in the form hydraulic cylinders which are part of a hydraulic circuit, and is also adapted to be attached to said plate forming said first blocking elements while being coupled with said conical hole of said first blocking elements;
said lower part of said locking rod is adapted to be vertically operated by said hydraulic means in the form of hydraulic cylinders housed in said upper part of the locking rod so as to alternatively be in the blocking position or the unblocking position;
said hydraulic cylinders are adapted to be controlled by a control-command device adapted to be connected to the control-command device of said wind generator;
said operation of the drive mechanism, through which the connecting part is connected to the hub, causes said connecting part to rotate around the central axis of the end of said connecting part connected to said hub, said rotation causes the blade connected to the other end of said connecting part to tilt, said tilting being operated such that either said blade, once tilted, is inclined according to an angle with respect to its operating position in the direction of the nacelle and the support tower, this inclined position is the safety position of said blade, or conversely said blade is inclined according to an angle with respect to said safety position in said operating position, said operating position of said blade corresponds in the present invention to the position of said blade allowing said wind generator to produce electricity, the orientation of said end of said connecting part connected to said hub in said operating position of said blade is determined for obtaining the largest surface swept by the rotor without said blade risking to collide with the support tower of said wind generator due to its deviation during the rotation of the rotor, preferably, in said safety position of said blade, and without it being limiting, the longitudinal axis of said blade is more or less perpendicular to the longitudinal axis of said support tower, and, preferably, in the case of said wind generator comprising several blades and without it being limiting, the longitudinal axes of each of said blades are more or less parallel to each other, as well as more or less perpendicular to said longitudinal axis of said support tower;
said variable pitch setting mechanism of the blade, through which the connecting part is connected to said blade, can be a friction or non-friction or low-friction mechanism, said variable pitch setting mechanism of said blade can incorporate, but is not limited to, a rolling bearing comprised of a rolling inner crown attached to the base of said blade by bolts and of a rolling outer crown attached by bolts to the other end of said connecting part connected to said blade, between said rolling inner crown and said rolling outer crown are arranged balls or rollings by which said rolling inner crown, said rolling outer crown and said balls or rollings form a rolling bearing allowing said variable pitch setting of said blade;
to reach this goal, said variable pitch setting mechanism is adapted to be operated by electrical or hydraulic operating means which are adapted to be controlled by a control-command device adapted to be connected to the control-command device of said wind generator;
the operation of said variable pitch setting mechanism of the blade causes said blade to rotate around its longitudinal axis, said rotation of said blade allows to actively set the angle of attack of said blade according to an angle depending on the wind speed, and thus allows to optimize the electricity production of said wind generator as well as to control the loads acting on said blade;
said variable pitch setting mechanism of said blade is adapted to be operated either individually for each of said blades or collectively for all blades of said rotor;
said power transmission system of said wind generator connecting the rotor to the generator of said wind generator is adapted to be rigidly blocked by blocking elements, it may be any type of blocking elements, said power transmission system comprises either a low-speed shaft connected to a multiplier connected to a high-speed shaft connected to the generator, or a low-speed shaft connected to the generator, said blocking elements can incorporate, but are not limited to, first blocking elements comprised of a toothed lower jaw provided on a support arranged on the support frame of the nacelle, second blocking elements comprised of two connecting bars which are adapted to be attached to the support frame of said wind generator and to the support of said first blocking elements on either side of said first blocking elements as well as on either side of third blocking elements comprised of a toothed upper jaw, said first and third blocking elements are aligned below and above fourth blocking elements, respectively, comprised of a toothed crown provided on said low-speed shaft or said high-speed shaft, said fourth blocking elements are adapted to cooperate with said first and third blocking elements by shape and position complementarity, for forming a blocking position of the power transmission system;
to reach this goal, said first and third blocking elements are adapted to vertically move along said connecting bars toward said fourth blocking elements via, without it being limiting, a toothed gear-type drive mechanism laterally provided on either side on said first and third blocking elements in the form of pinions operated by reversible electrical motors, as well as each of said second blocking elements in the form of racks adapted to cooperate with said pinions by shape and position complementarity, respectively, thereby forming by rigidly coupling said first, third and fourth blocking elements a blocking position of said power transmission system blocking the rotation of the rotor, and, conversely, forming thereby an unblocking position of said power transmission system allowing said rotation of said rotor;
said motors operating said pinions meshing with the teeth of said racks are adapted to each be controlled by a control-command device adapted to be connected to the control-command device of said wind generator.

Another object of the invention is a wind generator provided with such a device for protecting said wind generator in the event of violent winds, the nacelle of said wind generator is adapted to be rotatably mounted on a support tower behind the rotor via an orientation mechanism, it can be a wind generator facing the wind or downwind with a direct drive or a multiplier, sensors are arranged at strategic locations of said wind generator, said sensors are adapted to resist in the vent of violent winds, and allow to measure the speed or the speed and the direction of the wind, said sensors transmit the information collected in the most suitable form to the control-command device of said wind generator which defines and implements the suitable pitch setting angle of the blade or blades, as well as the suitable orientation of said nacelle with respect to the wind direction in the event of violent winds, said control-command device of said wind generator is adapted to be remotely controlled, from the operation centre of the wind generator, for receiving and then operating the controls required for operating said device for protecting said wind generator, said control-command device of said wind generator is also adapted to remotely transmit to the operation centre of the wind generator the information relating to the operating parameters of said device for protecting said wind generator as well as the information relating to the operating parameters of said wind generator; in addition and advantageously, said wind generator is adapted to be electrically supplied by an autonomous and independent electrical source of the electrical network in case of a power cut thereof.

Furthermore, an object of the invention is a method for protecting the wind generator in the event of violent winds. This method is characterized in that it comprises the phases consisting in:
selecting and sizing the parts, systems, processes, mechanisms, circuits, interfaces of the device for protecting the wind generator;
taking into account, in the conceptual arrangements of the wind generator, the impact of the features of the device for protecting the wind generator, as well as the loads and load cases induced by the installation and operation of the device for protecting the wind generator on the wind generator;
obtaining the weather information relating to the formation and the movement of violent wind phenomena from a specialized regional meteorological centre;
when the probability of occurrence of a violent wind event is proved, taking the decision to operate the device for protecting the wind generator such that the wind speed on the site where the wind generator is installed is within the range of that allowing to operate the device for protecting the wind generator;
all operations relating to the operation of the device for protecting the wind generator as shown below are automatically and remotely performed from the wind generator operation centre by sending, by selected communication means, a command for placing in protection position or placing in operating state position or for starting the wind generator, to the control-command device of the wind generator pre-programmed to that end;
the remote operation of the command for placing in protection position the wind generator triggers a sequence of automatic operations differing according to the number of blade(s) of the wind generator such that the tilting of the blade or blades is not blocked by the support tower of the wind generator. The next sequence presented herein, which is not limiting, relates to a wind generator comprising 3 blades connected to three connecting parts, respectively, connected at equal distances from each other to the hub, in the circumferential direction of said hub, and is to be adapted according to the number of blades of the wind generator. From the operating state position of the wind generator, characterized by the operating position of the blades, the connecting parts rigidly coupled to the hub and the unblocked rotation of the rotor, the sequence of automatic operations for placing in the protection position said wind generator comprises the phases consisting in:
   stopping the rotor, the central axis of the end connected to the hub of one of the three connecting parts is in the 6 o'clock position with respect to the rotation axis of the hub;
   placing in feathered position the blades of the wind generator;
   blocking the rotor by operating the blocking elements of the power transmission system of the wind generator;
   unblocking the blocking elements, which block the connecting part to the hub, both connecting parts, the central axis of the end of which, connected to the hub, is in the 10 o'clock position for one and the 2 o'clock position for the other with respect to the rotation axis of the hub;
   operating the drive mechanism of both connecting parts, the central axis of the end connected to the hub of which is in the 10 o'clock position for one and the 2 o'clock position for the other with respect to the rotation axis of the hub, the pitch setting of the two blades which are connected to these two connecting parts is active so as to promote the rotation of the drive mechanism, the operation of the drive mechanism causes these two connecting parts to rotate around the central axis of their end connected to the hub, which causes the blades which are connected to the other end of these two connecting parts to tilt, once tilted according to an angle with respect to their operating position, the two blades are inclined in the direction of the nacelle and of the support tower of the wind generator, in their safety position, the variable pitch setting mechanism of these two blades is active so as to limit the loads acting thereon;
   blocking the blocking elements, which block the connecting part to the hub, both connecting parts, the central axis of the end connected to the hub of which is in the 10 o'clock position for one and the 2 o'clock position for the other with respect to the rotation axis of the hub;
   unblocking the rotor by operating the blocking elements of the power transmission system of the wind generator;
   rotating the rotor according to a 60° angle with respect to the rotation axis of the hub in the counterclockwise direction, the connecting part, the central axis of the end connected to the hub of which was in the 6 o'clock position with respect to the rotation axis of the hub, has its central axis of the end connected to the hub in the 4 o'clock position with respect to the rotation axis of the hub;
   blocking the rotor by operating the blocking elements of the power transmission system of the wind generator;
   unblocking the blocking elements, which block the connecting part to the hub, the connecting part, the central axis of the end connected to the hub of which is in the 4 o'clock position with respect to the rotation axis of the hub;
   operating the drive mechanism of the connecting part, the central axis of the end connected to the hub of which is in the 4 o'clock position with respect to the rotation axis of the hub, the pitch setting of the blade which is connected to this connecting part is active so as to promote the rotation of the drive mechanism, the operation of the drive mechanism causes this connecting part to rotate around the central axis of its end connected to the hub, which causes the blade which is connected to the other end of this connecting part to tilt, once tilted according to an angle with respect to their operating position, the blade is inclined in the direction of the nacelle and of the support tower of the wind generator, in their safety position, the variable pitch setting mechanism of this blade is active so as to limit the loads acting thereon;
   blocking the blocking elements, which block the connecting part to the hub, the connecting part, the central axis of the end connected to the hub of which is in the 4 o'clock position with respect to the rotation axis of the hub;
   electrically supplying said wind generator by the autonomous and independent electrical source of the electrical network provided in case of a power cut thereof.
   The thus-formed position is the position for protecting the wind generator in the event of violent winds of the present invention. Said protection position is characterized by the blades in their safety position, the connecting parts rigidly blocked to the hub and the blocked rotation of the rotor. During this operation and in this position, the orientation mechanism of the nacelle with respect to the wind direction is active.
After the violent wind event has dissipated and the probability of occurrence of this risk is definitely ruled out by the specialized regional meteorological centre, the command for placing the wind generator back in its operating state is remotely sent to the control-command system of the wind generator, which triggers the sequence opposite to that previously-described such that the connecting parts are blocked to the hub in the operating position of the blades and that the power transmission system of said wind generator is unblocked;
When said wind generator is in its operating state position, an automatic self-control sequence of the functions of the wind generator is operated by the control-command device of said wind generator and gives rise to a report transmitted to the operation centre of said wind generator, if the transmitted report is positive, said wind generator is re-operated by the corresponding remote control of the control-command device of the wind generator, if said wind generator is damaged, the required measures are taken by the operation centre of the wind generator.

The device and method for protecting a wind generator in the event of violent winds and a wind generator provided with such a device have been presented.

This device for reducing the diameter size of the blade rotor is specific to the problem of violent wind events, and simple with only two remotely-operable positions of the rotor. The conceptual arrangements of the connecting part allow to reduce its mass while optimizing its strength and its rigidity, and the structural arrangements of the blades are not altered. Blocking the connecting part to the hub allows to limit the impact of aerodynamic load due to the wind of the drive mechanism of the connecting part, which increases its reliability. This simplicity makes the device efficient, robust and economical. In addition, the device for protecting the wind generator allows the latter to stand the impact of gusts of violent winds, the direction of which is different from that of the prevailing wind. Furthermore, this device is simple to design, produce, install, use and maintain. The device overcomes thus the drawbacks of the prior art.

### BRIEF DESCRIPTION OF THE DRAWINGS

Other features and advantages of the present invention will be more apparent with the following description of a non-limiting embodiment of the present invention, with reference to the accompanying drawings in which:

FIG. 1 is a cross-sectional partial schematic view of a wind generator of the prior art;

FIG. 2 is a three quarter face partial schematic view of the connecting part according to the invention;

FIG. 3 is a three quarter rear partial schematic view of the connecting part equipped with two reinforcing bars according to the invention;

FIG. 4 is a front partial schematic view of a wind generator equipped with the connecting part for connecting a wind generator blade to the wind generator hub, each blade being equipped with said connecting part, according to the invention;

FIG. 5 is a cross-sectional partial schematic view of the end of the connecting part connected to the hub according to the invention;

FIG. 6 is a cross-sectional partial schematic view of a wind generator equipped with the connecting part for connecting a wind generator blade to the wind generator hub, showing the action stroke of the tilting of the blade, from its operating position to its safety position, according to the invention;

FIG. 7 is a top partial schematic view of the rolling bearing equipping the base of the blade and of the end of the connecting part connected to the blade according to the invention;

FIG. 8 is a cross-sectional partial schematic view of the end of the connecting part connected to the blade according to the invention;

FIG. 9 is a cross-sectional partial schematic view of a wind generator equipped with blocking elements of the power transmission system according to the invention;

FIG. 10 is a partial schematic representation of the commands of the control-command device of the wind generator with respect to the device for protecting the wind generator according to the invention.

In the figures, identical or similar elements have the same reference signs, scales between the figures do not match with each other, and scales on the figures do not match with the size of the parts and mechanisms in order to clearly highlight them.

### BEST MODE TO IMPLEMENT THE INVENTION

In the following detailed descriptions, many specific details are defined so as to provide a thorough understanding of the conceptual arrangements representing the essential functions of the present invention. The parts, systems, mechanisms, processes, interfaces and circuits well known to the person skilled in the art are not presented here in order not to obfuscate the present invention.

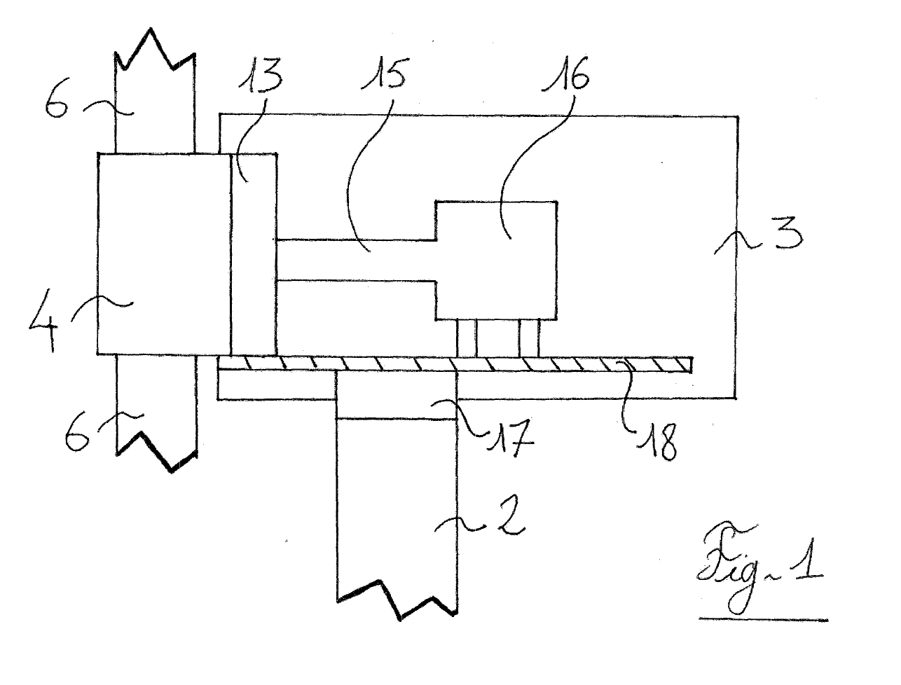

With reference to FIG. 1, a wind generator (1) of the prior art conventionally comprises one or several blade(s) (6) attached at equal distances from each other to a hub (4), this blade(s) (6)-hub (4) assembly forms the rotor, said rotor is connected to a power transmission system comprised of a low-speed shaft (not represented) connected to a multiplier (13) connected to a high-speed shaft (15), the power transmission system is connected to a generator (16) which produces electricity. The power transmission system and the generator (16) are housed on a support frame (18) itself housed within a nacelle (3), the support frame (18) and the nacelle (3) are rotatably mounted on a support tower (2) via an orientation mechanism (17). The peripheral equipments, such as inverters, the control and handling equipments, the hydraulic systems, etc. are not represented.

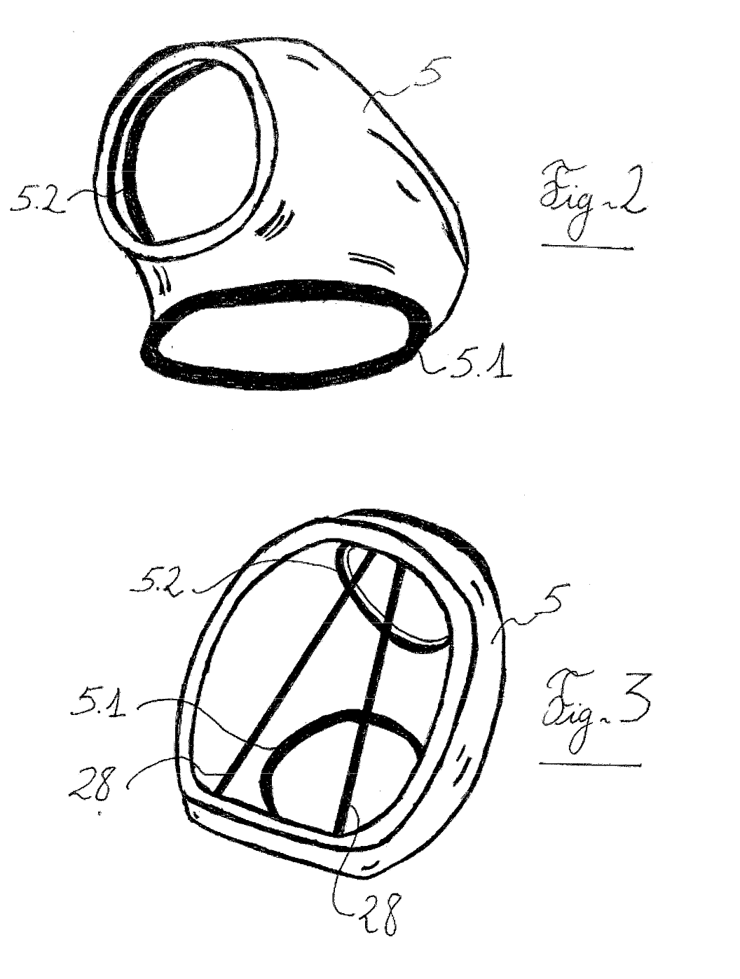

With reference to FIGS. 2, 3 and 4, the device according to the invention comprises a connecting part (5) for connecting a blade (6) of the wind generator (1) to the hub (4) of said wind generator (1), said wind generator (1) comprises three blades (6) and thus three connecting parts (5), said hub (4) comprises a port at each location of said connecting part (5).

with reference to FIG. 2 according to the invention, said connecting part (5) comprises two ends (5.1-5.2) which are two circular connecting flanges connected by a hollow tube, the material of which is characterized by its strength and its rigidity.

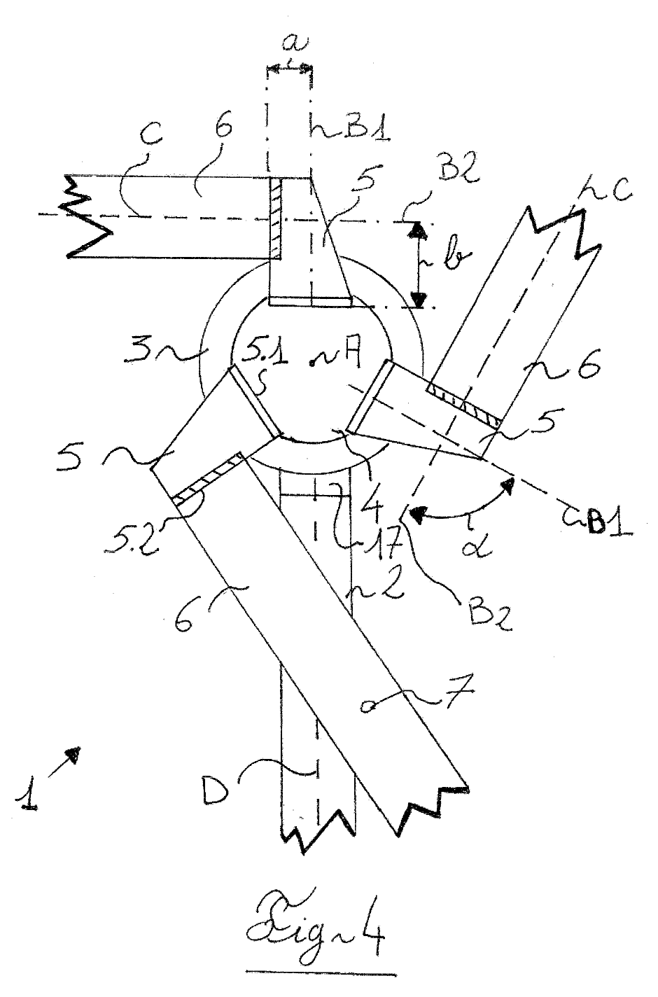

With reference to FIG. 3 according to the invention, the walls of the periphery of said hollow tube facing said ends (5.1-5.2) are partially removed and connected by two reinforcing bars (28).

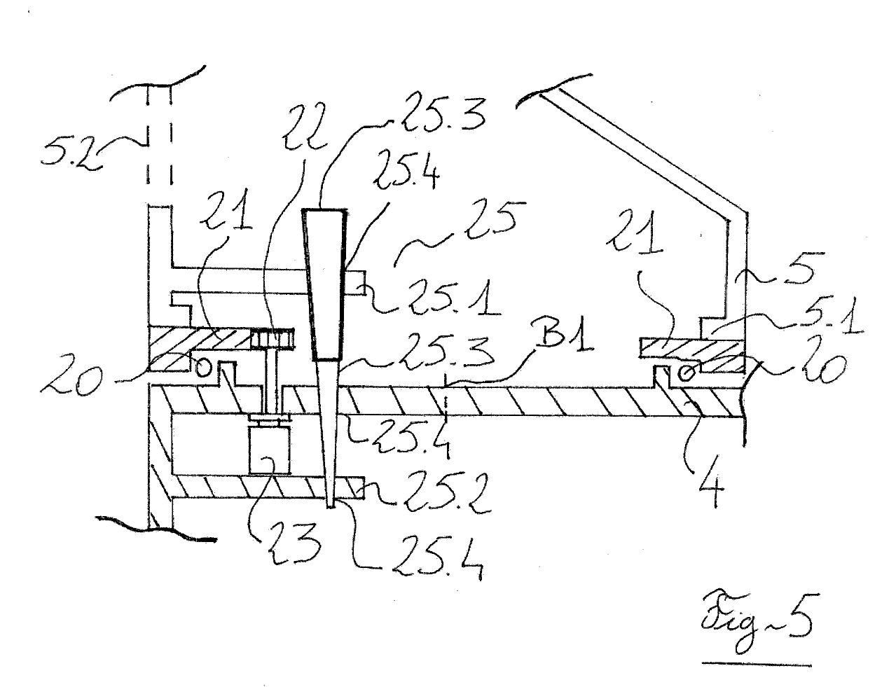

With reference to FIG. 4 according to the invention, said end (5.1) of said connecting part (5) is at a distance (b) from the central axis (B2) of the other end (5.2), said distance (2) depending on the size of said nacelle (3), said other end (5.2) of said connecting part (5) is at a distance (a) from the central axis (B1) of said end (5.1), said distance (a) being equal to the radius of said end (5.1) of the connecting part (5).

Both said ends (5.1-5.2) of said connecting part (5) are also characterized by the fact that their respective central axis (B1-B2) form a 90° angle ( ) with respect to each (B1) other (B2).

Said connecting parts (5) are connected at an equal distance from each other around the hub (4), and in the circumferential direction of said hub (4), the central axis (B1) of said end (5.1) of said connecting part (5) extends in a radial direction with respect to the rotation axis (A) of said hub (4).

The nacelle (3) of said wind generator (1) is rotatably mounted on a support tower (2) via an orientation mechanism (17) for orientating the nacelle (3), the rotation axis (A) of the hub being perpendicular to the longitudinal axis (D) of the support tower (2). The reference 7 corresponds to sensors adapted to measure and transmit the speed or the speed and the direction of the wind to the control-command device (30) according to FIG. 10 of said wind generator (1).

With reference to FIG. 5 according to the invention, said end (5.1) of said connecting part (5) connected to the hub (4) is adapted to be connected to said hub (4) of said wind generator (1) via a drive mechanism which comprises, without it being limiting, a crown (21) the upper internal periphery of which is toothed, said toothed crown (21) is circularly attached to the end of said end (5.1) of said connecting part (5), a pinion (22) meshing with the teeth of said toothed crown (21), said pinion (22) is operated by a reversible electrical motor (23).

A rolling bearing (20) is attached to the lower internal periphery of said toothed crown (21) and to the external periphery of the port of said hub (4) such that said end (5.1) of said connecting part (5) can rotate around its central axis (B1) when said motor (23) is operated.

Said motor (23) is adapted to be controlled by a control-command device (not represented) which is adapted to be connected to the control-command device (30) according to FIG. 10 of said wind generator (1).

Said end (5.1) of said connecting part (5) is also adapted to be blocked by rigid coupling to the hub (4) via blocking elements (25) which comprise, without it being limiting, plates (25.1) provided on said end (5.1) of said connecting part (5) above said toothed crown (21) forming the first blocking elements (25.1), and on said hub (4) forming the second blocking elements (25.2), said plates (25.1-25.2) protruding toward the central axis (B1) of said end (5.1) of said connecting part (5) perpendicularly to said central axis (B1).

Said first (25.1) and second (25.2) blocking elements are provided with conical holes (25.4) adapted to be aligned with each other when said connecting part (5) must be blocked.

A conical locking rod (25.3), comprised of a fixed upper part which is adapted to receive a lower part adapted to vertically move, forms the third blocking elements (25.3) said lower part of the locking rod (25.3) is adapted to be inserted in said holes (25.4) aligned for rigidly coupling said connecting part (5) to the hub (4).

Said fixed upper part of said locking rod (25.3) is adapted to receive hydraulic means in the form of hydraulic cylinders (not represented) which form part of a hydraulic circuit (not represented), and is also adapted to be attached to said plate (25.1) forming said first blocking elements (25.1) by being coupled to said conical hole (25.4) of said first blocking elements (25.1).

Said lower part of said locking rod (25.3) is adapted to be vertically operated by said hydraulic means in the form of hydraulic cylinders housed within said upper part of the locking rod (25.3) so as to be alternatively in a blocking position or in an unblocking position.

Said hydraulic cylinders are adapted to be controlled by a control-command device (not represented) adapted to be connected to the control-command device (30) according to FIG. 10 of said wind generator (1).

Said first (25.1), second (25.2) and third (25.3) blocking elements form a blocking mechanism (25), without it being limiting, four blocking mechanisms (25) are provided for each connecting part (5), said hydraulic cylinders of these blocking mechanisms (25) are part of the same hydraulic circuit, said four blocking mechanisms (25) are circularly attached at an equal distance from each other.

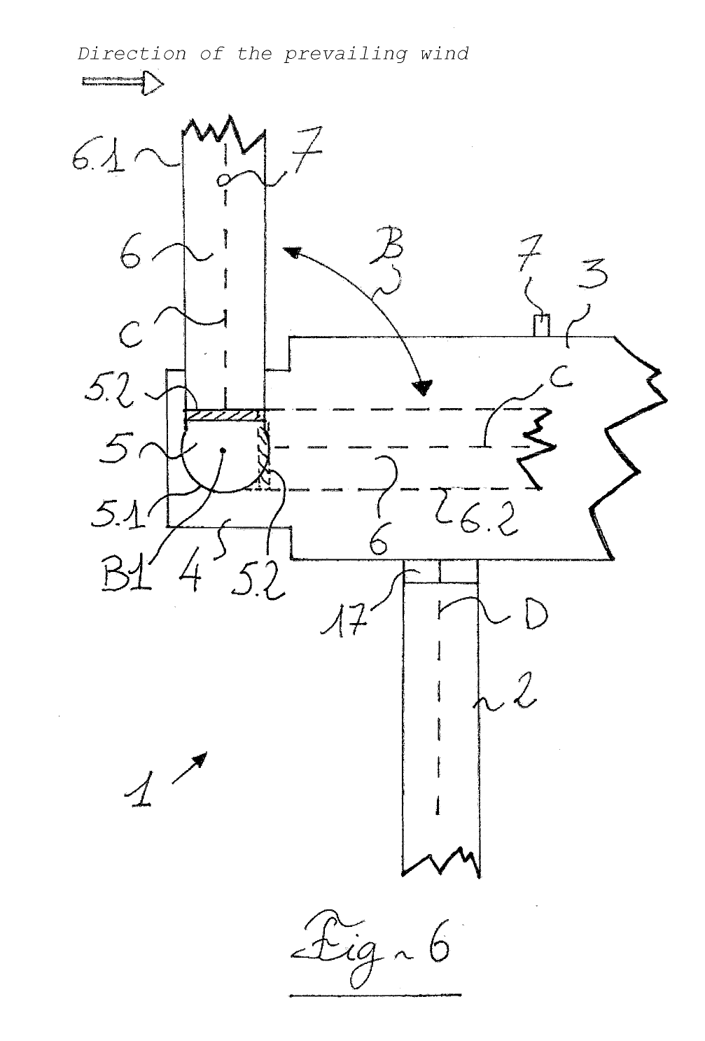

With reference to FIG. 6 according to the invention, the operation of said drive mechanism, through which the connecting part (5) is connected to the hub (4), causes said connecting part (5) to rotate around the central axis (B1) of said end (5.1) of said connecting part (5), said rotation causes said blade (6) connected to the other end (5.2) of said connecting part (5) to tilt.

Said tilting is performed such that either said blade (6), once tilted, is inclined according to a 90° angle (β) with respect to its operating position (6.1) in the direction of the nacelle (3) and of the support tower (2), this inclined position (6.2) being the safety position (6.2) of said blade (6), or conversely said blade (6) is inclined according to a 90° angle (β) with respect to said safety position (6.2) in said operating position (6.1).

Said operating position (6.1) of said blade (6) corresponds, in the present invention, to the position of said blade (6) allowing said wind generator (1) to produce electricity, the orientation of said end (5.1) of said connecting part (5) connected to the hub (4) in said operating position (6.1) of said blade (6) is determined so as to obtain the largest surface swept by said rotor, without said blade (6) risking to collide with said support tower (2) of said wind generator (1) due to its deviation during the rotation of said rotor, in the present embodiment said operating position (6.1) of said blade (6) corresponds to an inclination of 0° of the longitudinal axis (C) of said blade (6) with respect to the rotation plane formed by the central axis (B1) of the end (5.1) of the connecting part (5).

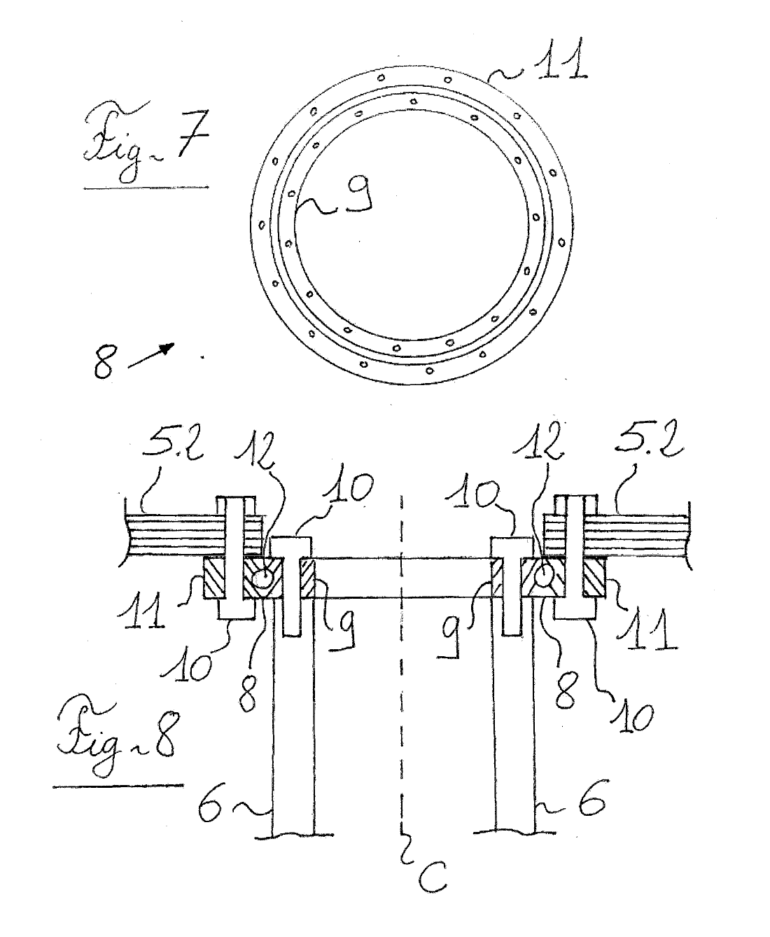

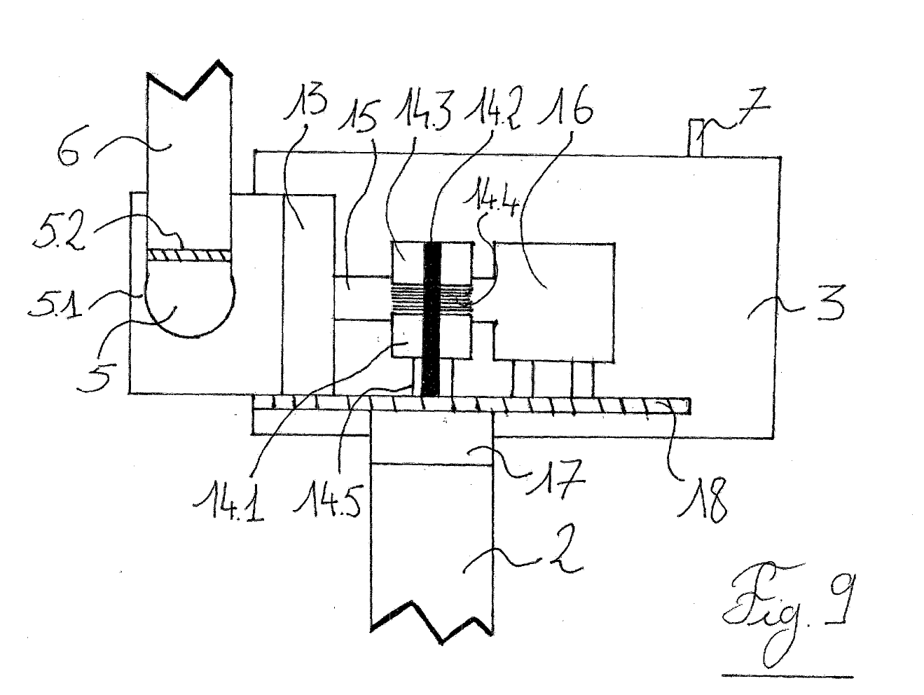

With reference to FIGS. 7 and 8 according to the invention, said other end (5.2) of said connecting part (5) connected to said blade (6) of said wind generator (1) is adapted to be connected to said blade (6) of said wind generator (1) via a variable pitch setting mechanism of said blade (6) which comprises, without it being limiting, a rolling bearing (8) comprised of a rolling inner crown (9) attached to the base of said blade (6) by bolts (10), and a rolling outer crown (11) attached by bolts (10) to said other end (5.2) of said connecting part (5) connected to said blade (6), between said rolling inner crown (9) and said rolling outer crown (11) are housed the balls or bearings (12) by which said rolling inner crown (9), said rolling outer crown (11) and said balls or bearings (12) form a rolling bearing (8) allowing said variable pitch setting of said blade (6).

To reach this goal, said variable pitch setting mechanism can be operated by electrical or hydraulic means (not represented) which are adapted to be controlled by a control-command device (not represented) adapted to be connected to the control-command device (30) according to FIG. 10 of said wind generator (1).

The operation of said variable pitch setting mechanism of said blade (6) causes said blade (6) to rotate around its longitudinal axis (C), said rotation of said blade (6) allows to actively set the angle of attack of said blade (6) at some angle according to the speed of the wind, and allows thus to optimize the electricity production of said wind generator (1) as well as control the loads acting on said blade (6), said variable pitch setting mechanism of said blade (6) is adapted to be operated either individually for each of said blades (6) or collectively for all blades (6) of the rotor.

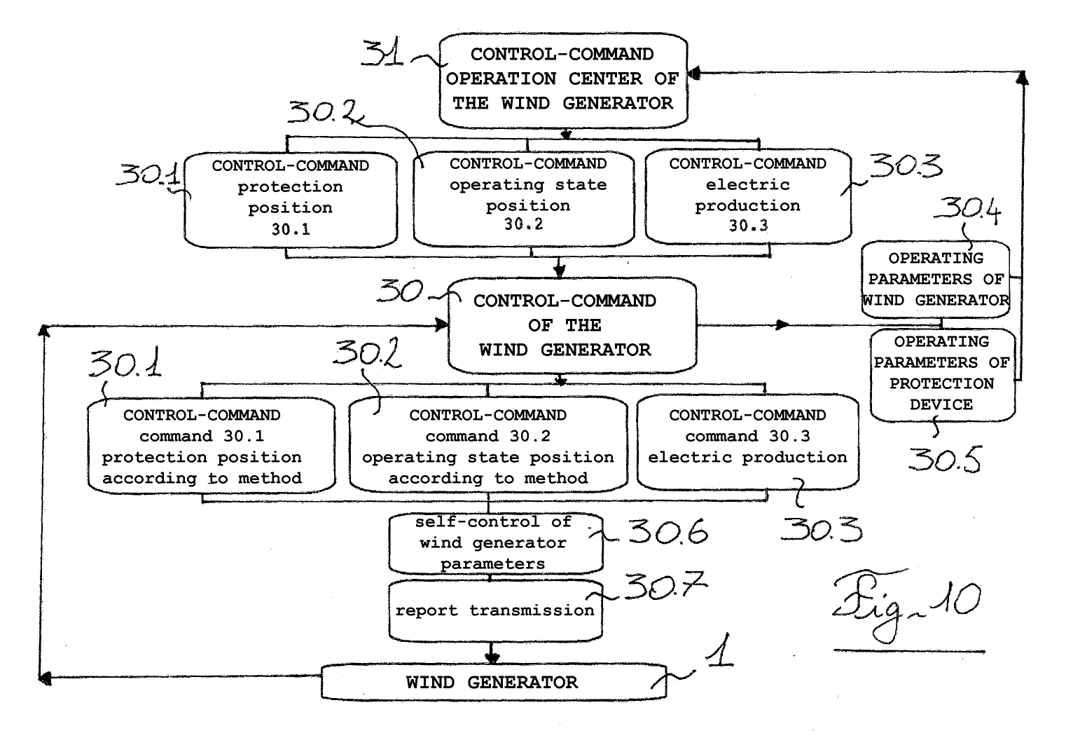

With reference to FIG. 9 according to the invention, the power transmission system of said wind generator (1) connecting the rotor to the generator (16) of said wind generator (1) is comprised of a low-speed shaft (not represented), a multiplier (13) and a high-speed shaft (15), said high-speed shaft (15) is adapted to be rigidly blocked by blocking elements (14) which comprise, without it being limiting, first blocking elements (14.1) comprised of a toothed lower jaw (14.1) provided on a support (14.5) housed on the support frame (18) of the nacelle (3), second blocking elements (14.2) comprised of two connecting bars (14.2) which are adapted to be attached to the support frame (18) of said wind generator (1) and to the support (14.5) of said first blocking elements (14.1) on either side of said first blocking elements (14.1) as well as on either side of the third blocking elements (14.3) comprised of a toothed upper jaw (14.3), said first (14.1) and third (14.3) blocking elements being aligned respectively below and above the fourth blocking elements (14.4) comprised of a toothed crown (14.4) provided on said high-speed shaft (15) and which are adapted to cooperate with said first (14.1) and third (14.3) blocking elements by shape and position complementarity for forming a blocking position of the power transmission system.

To reach this goal, said first (14.1) and third (14.3) blocking elements are adapted to vertically move along said connecting bars (14.2) toward said fourth blocking elements (14.4) via, without it being limiting, a toothed gear-type drive mechanism (not represented), forming thereby, by rigidly coupling said first (14.1), third (14.3) and fourth (14.4) blocking elements, a blocking position of said power transmission system blocking the rotation of the rotor, and conversely, forming thereby an unblocking position of said power transmission system allowing said rotation of said rotor.

Said toothed gear-type drive mechanism comprises, without it being limiting, a rack provided on each of said connecting bars (14.2), two pinions laterally housed within said first blocking elements (14.1), namely a pinion on either side of said first blocking elements (14.1) adapted to cooperate, by shape and position complementarity, with each of the racks provided on said connecting bars (14.2), two other pinions laterally housed within said third blocking elements (14.3), namely a pinion on either side of said third blocking elements (14.3) adapted to cooperate, by shape and position complementarity, with each of said racks provided on said connecting bars (14.2).

Said pinions meshing with the teeth of each of said racks are adapted to be individually operated by reversible electrical motors (not represented) which are adapted to be controlled by a control-command device (not represented) adapted to be connected to the control-command device (30) according to FIG. 10 of said wind generator (1).

With reference to FIG. 10 according to the invention, the control-command device (30) of said wind generator (1) is adapted to be remotely controlled from the operation centre (31) of said wind generator (1) for receiving and then operating the commands for placing in protection position (30.1), or in operating state position (30.2) or for starting the electrical production (30.3) of said wind generator (1) required for the operation of said device for protecting said wind generator (1) according to the method of the present invention.

Said control-command device (30) of said wind generator (1) is also adapted to remotely transmit to the wind generator operation centre (31) the information relating to the operating parameters (30.5) of said device for protecting said wind generator (1) as well as the information (30.4) relating to the operating parameters of said wind generator (1). An automatic sequence (30.6) for controlling the functions of said wind generator (1) is operated by the control-command device (30) of said wind generator (1) when in the operating state, after the event of violent winds, and gives rise to a report (30.7) transmitted to the operation centre (31) of said wind generator (1).

The device for protecting the wind generator (1) in the event of violent winds operates according to the invention in the following manner:

when the probability of occurrence of an event of violent winds is proved, taking the decision to operate the device for protecting the wind generator (1) such that the wind speed on the site where the wind generator (1) is installed is within a range of that allowing to operate the device for protecting the wind generator (1).

All operations relating to the operation of the device for protecting the wind generator (1) as shown below are automatically and remotely performed from the wind generator operation centre (31) by sending, by selected communication means, a command for placing in protection position (30.1) or placing in operating state position (30.2) or for starting the wind generator (30.3), to the control-command device (30) of the wind generator pre-programmed to that end.

The remote operation of the command for placing in protection position (30.1) the wind generator triggers a sequence of automatic operations differing according to the number of blade(s) (6) of the wind generator (1) such that the tilting of the blade or blades (6) is not blocked by the support tower (2) of the wind generator (1). The next sequence presented herein, which is non-limiting, relates to a wind generator (1) comprising 3 blades (6) connected to three connecting parts (5), respectively, connected at an equal distance from each other to the hub (4), in the circumferential direction of said hub (4), and is to be adapted according to the number of blades (6) of the wind generator (1). From the operating state position of the wind generator (1), characterized by the operating position (6.1) of the blades (6), the connecting parts (5) rigidly coupled to the hub (4) and the unblocked rotation of the rotor, the sequence of automatic operations for placing in the protection position said wind generator (1) comprises the phases consisting in:
stopping the rotor, the central axis of the end (5.1) connected to the hub (4) of one of the 3 connecting parts (5) is in the 6 o'clock position with respect to the rotation axis (A) of the hub;
placing in feathered position the blades (6) of the wind generator (1);
blocking the rotor by operating the blocking elements (14) of the power transmission system of the wind generator (1);
unblocking the blocking elements (25), which block the connecting part (5) to the hub (4), both connecting parts (5), the central axis (B1) of the end (5.1) of which, connected to the hub (4), is in the 10 o'clock position for one and the 2 o'clock position for the other with respect to the rotation axis (A) of the hub;
operating the drive mechanism of both connecting parts (5), the central axis (B1) of the end (5.1) connected to the hub (4) of which is in the 10 o'clock position for one and the 2 o'clock position for the other with respect to the rotation axis (A) of the hub, the pitch setting of the two blades (6) which are connected to these two connecting parts (5) is active so as to promote the rotation of the drive mechanism, the operation of the drive mechanism causes these two connecting parts (5) to rotate around the central axis (B1) of their end (5.1) connected to the hub (4), which causes the blades (6) which are connected to the other end (5.2) of these two connecting parts (5) to tilt, once tilted according to an angle (β) with respect to their operating position (6.1), the two blades (6) are inclined in the direction of the nacelle (3) and of the support tower (2) of the wind generator (1), in their safety position (6.2), the variable pitch setting mechanism of these two blades (6) is active so as to limit the loads acting thereon;
blocking the blocking elements (25), which block the connecting part (5) to the hub (4), both connecting parts (5), the central axis (B1) of the end (5.1) connected to the hub (4) of which is in the 10 o'clock position for one and the 2 o'clock position for the other with respect to the rotation axis (A) of the hub;
unblocking the rotor by operating the blocking elements (14) of the power transmission system of the wind generator (1);
rotating the rotor according to a 60° angle with respect to the rotation axis (A) of the hub in the counterclockwise direction, the connecting part (5), the central axis (B1) of the end (5.1) connected to the hub (4) of which was in the 6 o'clock position with respect to the rotation axis (A) of the hub, has its central axis (B1) of the end (5.1) connected to the hub (4) in the 4 o'clock position with respect to the rotation axis (A) of the hub;
blocking the rotor by operating the blocking elements (14) of the power transmission system of the wind generator (1);
unblocking the blocking elements (25), which block the connecting part (5) to the hub (4), the connecting part (5), the central axis (B1) of the end (5.1) connected to the hub (4) of which is in the 4 o'clock position with respect to the rotation axis (A) of the hub;
operating the drive mechanism of the connecting part (5), the central axis (B1) of the end (5.1) connected to the hub (4) of which is in the 4 o'clock position with respect to the rotation axis (A) of the hub, the pitch setting of the blade (6) which is connected to this connecting part (5) is active so as to promote the rotation of the drive mechanism, the operation of the drive mechanism causes this connecting part (5) to rotate around the central axis (B1) of its end (5.1) connected to the hub (4), which causes the blade (6) which is connected to the other end (5.2) of this connecting part (5) to tilt, once tilted according to an angle (β) with respect to their operating position (6.1), the blade (6) is inclined in the direction of the nacelle (3) and of the support tower (2) of the wind generator (1), in its safety position (6.2), the variable pitch setting mechanism of this blade (6) is active so as to limit the loads acting thereon;
blocking the blocking elements (25), which block the connecting part (5) to the hub (4), the connecting part (5), the central axis (B1) of the end (5.1) connected to the hub (4) of which is in the 4 o'clock position with respect to the rotation axis (A) of the hub;
electrically supplying said wind generator (1) by the autonomous and independent electrical source of the electrical network provided in case of a power cut thereof.

The thus-formed position is the position for protecting the wind generator in the event of violent winds of the present invention. Said protection position is characterized by the blades (6) in the safety position (6.2), the connecting parts (5) rigidly blocked to the hub (4) and the blocked rotation of the rotor. During this operation and in this position, the orientation mechanism (17) of the nacelle (3) with respect to the wind direction is active.

After the violent wind event has dissipated and the probability of occurrence of this risk is definitely ruled out by the specialized regional meteorological centre, the command (30.2) for placing the wind generator (1) back in its operating state is remotely transmitted to the control-command system (30) of the wind generator (1), which triggers the sequence opposite to that previously-described such that the connecting parts (5) are blocked to the hub (4) in the operating position (6.1) of the blades (6) and that the power transmission system of said wind generator (1) is unblocked.

When said wind generator is in its operating state position, an automatic self-control sequence (30.6) of the functions of the wind generator (1) is operated by the control-command device (30) of said wind generator (1) and gives rise to a report (30.7) transmitted to the operation centre (31) of said wind generator (1), if the transmitted report (30.7) is positive, said wind generator (1) is re-operated by the corresponding remote command (30.3) of the control-command device (30) of the wind generator (1), if said wind generator (1) is damaged, the required measures are taken by the operation centre (31) of the wind generator (1).

The device according to the invention is particularly intended to allow an optimum and safe operation of wind generators (1) in regions subject to violent wind events, such as tropical cyclones.

1-7. (canceled)

8. A device for protecting a wind generator (1) in the event of violent winds, characterized in that it comprises a connecting part (5) of a blade (6) of a wind generator (1) to the hub (4) of said wind generator (1) comprising one or several blade(s) (6) and as many connecting parts (5) as blades (6), both ends (5.1-5.2) of said connecting part (5), one connected to the hub (4) and the other connected to the blade (6), are characterized by the fact that their respective central axis (B1-B2) forms a non-zero angle (α) with respect to each (B1) other (B2), the connecting part (5) is adapted to be connected to the hub (4) via a drive mechanism such that said connecting part (5) can rotate around the central axis (B1) of its end (5.1) connected to said hub (4), the operation of this drive mechanism causes the tilting according to an angle (β) of the blade (6) which is adapted to be connected to the other end (5.2) of the connecting part (5) via a variable pitch setting mechanism, when said blade (6) is tilted, it is inclined according to said angle (β) in the direction of the nacelle (3), in the safety position (6.2) or conversely in the operating position (6.1), the connecting part (5) is adapted to be blocked by rigidly coupling with the hub (4) by blocking elements (25), the power transmission system of said wind generator (1) is also adapted to be rigidly blocked by blocking elements (14) which block the rotation of the rotor, therefore the operations being performed on all connecting parts (5), the blades (6) inclined in the direction of the nacelle (3), the connecting parts (5) rigidly blocked to the hub (4) and the blocked rotation of the rotor form the protection position of said wind generator (1), remotely controllable in the event of violent winds, wherein said two ends (5.1-5.2) of the connecting part (5) are circular connecting flanges connected by a hollow tube, the walls of which facing said ends (5.1-5.2) are partially removed and connected by reinforcing bars (28), said end (5.1) of the connecting part (5) connected to the hub (4) is at a distance (b) from the central axis (B2) of the other end (5.2) of said connecting part (5) connected to the blade (6), said other end (5.2) of the connecting part (5) connected to the blade (6) is at a distance (a) from the central axis (B1) of the end (5.1) of said connecting part (5) connected to the hub (4), said connecting parts (5) are connected to the hub (4) at equal distances from each other in the case of said rotor comprising several blades (6), and in the circumferential direction of said hub (4), the central axis (B1) of the end (5.1) of said connecting part (5) connected to said hub (4) extends in a radial direction with respect to the rotation axis (A) of said hub.

9. The device according to claim 8, characterized in that said operating position (6.1) of said blade (6) corresponds, in the present invention, to the position of said blade (6) allowing said wind generator (1) to produce electricity, the orientation of said end (5.1) of said connecting part (5) connected to said hub (4) in said operating position (6.1) of said blade (6) is determined so as to obtain the largest surface swept by said rotor without said blade (6) which is connected to said other end (5.2) of said connecting part (5) risking to collide with said support tower (2) of said wind generator (1) due to its deviation during the rotation of said blade rotor.

10. A wind generator (1) characterized by the fact that it is provided with a device according to claim 8.

11. A wind generator (1) characterized by the fact that it is provided with a device according to claim 9.

12. The wind generator (1) according to claim 10, characterized in that sensors (7) are arranged at strategic locations of said wind generator (1), said sensors (7) are adapted to resist in the event of violent winds, and allow to measure the speed or the speed and the direction of the wind, said sensors (7) transmit the information collected in the most suitable form to the control-command device (30) of said wind generator which defines and implements the suitable pitch setting angle of the blade or blades (6), as well as the suitable orientation of said nacelle (3) with respect to the wind direction in the event of violent winds, said control-command device (30) of said wind generator is adapted to be remotely controlled, from the operation centre (31) of the wind generator (1), for receiving and then operating the controls (30.1-30.2-30.3-30.6-30.7) required for operating said device for protecting said wind generator, said control-command device (30) of said wind generator (1) is also adapted to remotely transmit the information relating to the operating parameters of said device (30.5) for protecting said wind generator (1) as well as the information relating to the operating parameters (30.4) of said wind generator (1).

13. A method for protecting a wind generator (1) in the event of violent winds, characterized in that it comprises the phases consisting in:
selecting and sizing the parts, systems, processes, mechanisms, circuits, interfaces of the device for protecting the wind generator (1);
taking into account, in the conceptual arrangements of the wind generator (1), the impact of the features of the device for protecting the wind generator (1), as well as the loads and load cases induced by the installation and operation of the device for protecting the wind generator (1) on the wind generator (1);
obtaining the weather information relating to the formation and the movement of violent wind phenomena from a specialized regional meteorological centre;
when the probability of occurrence of a violent wind event is proved, taking the decision to operate the device for protecting the wind generator (1) such that the wind speed on the site where the wind generator (1) is installed is within the range of that allowing to operate the device for protecting the wind generator (1);
wherein all operations relating to the operation of the device for protecting the wind generator (1) as shown below are automatically and remotely performed from the wind generator operation centre (31) by sending, by selected communication means, a command for placing in protection position (30.1) or placing in operating state position (30.2) or for starting the wind generator (30.3), to the control-command device (30) of the wind generator (1) pre-programmed to that end, and characterized by the next sequence presented herein, which relates to a wind generator (1) comprising 3 blades (6) connected to three connecting parts (5), respectively, connected at equal distances from each other to the hub (4), in the circumferential direction of said hub (4), and is to be adapted according to the number of blades (6) of the wind generator (1); wherein from the operating state position of the wind generator (1), characterized by the operating position (6.1) of the blades (6), the connecting parts (5) rigidly coupled to the hub (4) and the unblocked rotation of the rotor, the sequence of automatic operations for placing in the protection position said wind generator (1) comprises the phases consisting in:
stopping the rotor, the central axis of the end (5.1) connected to the hub (4) of one of the 3 connecting parts (5) is in the 6 o'clock position with respect to the rotation axis (A) of the hub;
placing in feathered position the blades (6) of the wind generator (1);
blocking the rotor by operating the blocking elements (14) of the power transmission system of the wind generator (1);
unblocking the blocking elements (25) which block the connecting part (5) to the hub (4), both connecting parts (5), the central axis (B1) of the end (5.1) of which, connected to the hub (4), is in the 10 o'clock position for one and the 2 o'clock position for the other with respect to the rotation axis (A) of the hub;
operating the drive mechanism of both connecting parts (5), the central axis (B1) of the end (5.1) connected to the hub (4) of which is in the 10 o'clock position for one and the 2 o'clock position for the other with respect to the rotation axis (A) of the hub, the pitch setting of the two blades (6) which are connected to these two connecting parts (5) is active so as to promote the rotation of the drive mechanism, the operation of the drive mechanism causes these two connecting parts (5) to rotate around the central axis (B1) of their end (5.1) connected to the hub (4), which causes the blades (6) which are connected to the other end (5.2) of these two connecting parts (5) to tilt, once tilted according to an angle (β) with respect to their operating position (6.1), the two blades (6) are inclined in the direction of the nacelle (3) and of the support tower (2) of the wind generator (1), in their safety position (6.2), the variable pitch setting mechanism of these two blades (6) is active so as to limit the loads acting thereon;
blocking the blocking elements (25), which block the connecting part (5) to the hub (4), both connecting parts (5), the central axis (B1) of the end (5.1) connected to the hub (4) of which is in the 10 o'clock position for one and the 2 o'clock position for the other with respect to the rotation axis (A) of the hub;
unblocking the rotor by operating the blocking elements (14) of the power transmission system of the wind generator (1);
rotating the rotor according to a 60° angle with respect to the rotation axis (A) of the hub in the counterclockwise direction, the connecting part (5), the central axis (B1) of the end (5.1) connected to the hub (4) of which was in the 6 o'clock position with respect to the rotation axis (A) of the hub, has its central axis (B1) of the end (5.1) connected to the hub (4) in the 4 o'clock position with respect to the rotation axis (A) of the hub;
blocking the rotor by operating the blocking elements (14) of the power transmission system of the wind generator (1);
unblocking the blocking elements (25), which block the connecting part (5) to the hub (4), the connecting part (5), the central axis (B1) of the end (5.1) connected to the hub (4) of which is in the 4 o'clock position with respect to the rotation axis (A) of the hub;
operating the drive mechanism of the connecting part (5), the central axis (B1) of the end (5.1) connected to the hub (4) of which is in the 4 o'clock position with respect to the rotation axis (A) of the hub, the pitch setting of the blade (6) which is connected to this connecting part (5) is active so as to enhance the rotation of the drive mechanism, the operation of the drive mechanism causes this connecting part (5) to rotate around the central axis (B1) of its end (5.1) connected to the hub (4), which causes the blade (6) which is connected to the other end (5.2) of this connecting part (5) to tilt, once tilted according to an angle (β) with respect to their operating position (6.1), the blade (6) is inclined in the direction of the nacelle (3) and of the support tower (2) of the wind generator (1), in its safety position (6.2), the variable pitch setting mechanism of this blade (6) is active so as to limit the loads acting thereon;
blocking the blocking elements (25) which block the connecting part (5) to the hub (4), the connecting part (5), the central axis (B1) of the end (5.1) connected to the hub (4) of which is in the 4 o'clock position with respect to the rotation axis (A) of the hub;
electrically supplying said wind generator (1) by the autonomous and independent electrical source of the electrical network provided in case of a power cut thereof;
wherein the thus-formed position is the position for protecting the wind generator in the event of violent winds of the present invention, wherein said protection position is characterized by the blades (6) in the safety position (6.2), the connecting parts (5) rigidly blocked to the hub (4) and the blocked rotation of the rotor, wherein during this operation and in this position, the orientation mechanism (17) of the nacelle (3) with respect to the wind direction is active;
after the violent wind event has dissipated and the probability of occurrence of this risk is definitely ruled out by the specialized regional meteorological centre, the command (30.2) for placing the wind generator (1) back in its operating state is remotely transmitted to the control-command system (30) of the wind generator (1), which triggers thereby the sequence opposite to that previously-described such that the connecting parts (5) are blocked to the hub (4) in the operating position (6.1) of the blades (6) and that the power transmission system of said wind generator (1) is unblocked;
when said wind generator is in its operating state position, an automatic self-control sequence (30.6) of the functions of the wind generator (1) is operated by the control-command device (30) of said wind generator (1) and gives rise to a report (30.7) transmitted to the operation centre (31) of said wind generator (1), if the transmitted report (30.7) is positive, said wind generator (1) is re-operated by the corresponding remote control (30.3) of the control-command device (30) of the wind generator (1), if said wind generator (1) is damaged, the required measures are taken by the operation centre (31) of the wind generator (1).
